(19) United States
(12) Patent Application Publication
(10) Pub. No.: US 2002/0140738 A1
(43) Pub. Date: Oct. 3, 2002

(54) Policy based approach to configuring menus and toolbars

(76) Inventors: Alan West, Edinburgh (GB); Ken Milne, Glasgow (GB)

Correspondence Address: Cary S. Kappel, DAVIDSON, DAVIDSON & KAPPEL, LLC, 485 Seventh Avenue, 14th Floor, New York, NY, 10018, US

(21) Appl. No.: 09/771,478

(22) Filed: Jan. 26, 2001

(51) Int. Cl. G09G 5/00

(52) U.S. Cl. 345/810; 345/764

(57) ABSTRACT

A system and method is provided for generating menu/toolbar entities on a graphical user interface having a parent frame for displaying menu/toolbar entities and a plurality of child frames. A set of applications is provided which can be displayed in the plurality of child frames. Each application has a corresponding set of menu/toolbar entities and information indicative of a policy for each menu/toolbar entity of each application is contained in a data file. Preferably, each application has a corresponding data file. A displayed set of menu/toolbar entities on the graphical user interface is generated based upon the policies of the menu/toolbar entities for a currently focused one of the applications.

### FIELD OF THE INVENTION

The present invention relates generally to the field of computer programs. Specifically, the present invention relates to a policy based approach to menu and toolbar items.

### BACKGROUND OF THE INVENTION

Software applications often make use of menus and toolbars to allow users to select different functions and options in a graphical user interface. Generally, menu items and tool items, which are associated with the functions and options, make up the menu or toolbar. Menus and toolbars function both in MDI environments and SDI environments. In an MDI (Multiple Document Interface) environment, a single parent window contains any number of child windows. The menus and/or toolbars associated with each child window are displayed on a frame of the parent window. In an SDI (Single Document Interface) environment, new windows are spawned for each user visible process or view, and a new menu and/or toolbar is placed on the frame of each new window.

In an MDI environment, the menus and toolbars, with their associated menu and tool bar items need to be modified as different applications are opened in the child windows, and as these applications gain or lose focus, so that an appropriate set of menus and toolbars are available to the user. The enabling, disabling, and changing of the menu and toolbar options are conventionally implemented by source level programming.

### SUMMARY OF THE INVENTION

In accordance with an embodiment of the present invention, a system and method is provided for generating menu/toolbar entities on a graphical user interface having a parent frame for displaying menu/toolbar entities and a plurality of child frames. A set of applications is provided which can be displayed in the plurality of child frames. Each application has a corresponding set of menu/toolbar entities and information indicative of a policy for each menu/toolbar entity of each application is contained in a data file. Preferably, each application has a corresponding data file. A displayed set of menu/toolbar entities on the graphical user interface is generated based upon the policies of the menu/toolbar entities for a currently focused one of the applications.

In the context of the present invention, the term “menu/toolbar entity” is meant to encompass tool bars with their associated tool bar items (e.g., buttons), as well as menu bars with their associated pull-down menus (hereinafter “menu” ), each in turn having respective menu items. Moreover, in the context of the present invention, an application is in focus (“currently focused application” ) when it is in the active window (i.e., the window with the cursor) and the terms gaining focus, and losing focus, and the like, refer to the transition of an application in and out of focus.

The policies of the menu/toolbar entities control the manner in which these entities are incorporated into the graphical user interface when the application gains focus. For example, a policy might indicate that the entity is to be added to a menu or a tool bar, that it is to replace another entity in a menu or a tool bar that corresponds to a current set of menu/toolbar entities, or that the entity is to have no affect whatsoever on the menu or the tool bar.

In accordance with one aspect of the above embodiment, the policy for each menu/tool bar entity is selected from a set of policies including a replace policy and an append policy, and information indicative of the policy is placed into the data file. In addition, each menu/toolbar entity has an identifier (e.g., a label), with the same or similar entities from different applications being provided with the same identifier. For each menu/toolbar entity in an application gaining focus, the identifier of the menu/toolbar entity is compared to the identifier of each menu/toolbar entity of a current set of menu/toolbar entities, and, upon finding a match: the matched menu/toolbar entity of the current set of menu/toolbar items is replaced with the matched menu/toolbar entity of the application gaining focus in the displayed set of menu/toolbar entities when the policy of the matched menu/toolbar entity of the application gaining focus is the replace policy, and the matched menu/toolbar entity of the application gaining focus is added to the displayed set of menu/toolbar entities when the policy of the matched menu/toolbar entity of the application gaining focus is the append policy. As discussed above, the set of menu/toolbar entities preferably includes a menu bar having a set of menus and corresponding menu items and a toolbar having a set of toolbar items, and the menu bar, the toolbar, each menu, each menu item, and each toolbar item each have a respective policy. Alternatively, policies could be provided for menu items and/or tool bar items, but not for the overlying menus, menu bars, and/or tool bars. Similarly, policies could be provided for only for the menu bars, only for the tool bars, or only for the menus.

In accordance with a further aspect of this embodiment, the policies further include a merge policy. When the merge policy is selected for a menu/toolbar entity, the policies of the “child” entities of that entity control the display of the “child” entities. For example, when a match is found for a menu (e.g. File) with a merge policy, the displayed set of menu/toolbar entities on the graphical user interface are based upon the policies of the menu items (e.g. new, open, etc.) of the matched menu of the application gaining focus. Similarly, when a match is found for a tool bar with a merge policy, the displayed set of menu/toolbar entities on the graphical user interface are based upon the policies of the tool bar items of the matched tool bar of the application gaining focus. The merge policy can also be used for menu items, when the menu item has sub-menu items such as the cascading sub-menus commonly found in menus. If a match is found for such a menu item having a merge policy, the displayed set of menu/toolbar entities on the graphical user interface are based upon the policies of the sub-menu items of the matched menu item of the application gaining focus.

Through the use of data file(s) to specify the policies for the applications, the present invention provides a graphical user interface which can easily be reconfigured by developers and/or users without the need to modify and compile source code. Moreover, the policies in the data file can be designated with self-explanatory alphanumeric strings such as REPLACE for the replace policy, making configuration of the menus and toolbars in the system in accordance with the present invention even more straight forward.

### BRIEF DESCRIPTION OF THE DRAWINGS

FIG. 1 shows an exemplary set of a menu bars and tool bars.

FIG. 2 shows a flow chart for a preferred system in accordance with the present invention.

FIG. 3 is an illustrative representation of the policies that can be defined for the overall menu bar (in situations in which there is more than one), each menu in the menu bar, each item on a menu bar, the overall toolbar (in situations in which there is more than one), and for each item on a toolbar.

FIG. 4 shows the policies that can be defined for items.

FIG. 5(a ) is an illustrative representation of a menu configuration showing the currently displayed menus.

FIG. 5(b ) is an illustrative representation of a menu configuration for an application.

FIG. 5(c ) is an illustrative representation of the menu bar after the application gains focus. FIG. 5(d ) is an illustrative representation of the menu bar after the application loses focus.

### DETAILED DESCRIPTION OF THE PREFERRED EMBODIMENTS

The present invention relates to a system for managing tool bars and menu bars in an application environment wherein a plurality of views are controlled via a single menu bar and one or more tool bars. In this context, a view refers to a display window, or display pane, which is displayed on a computer monitor or other display device. An example of such a system would be a MDI (multiple document interface) application running in a Windows 95/NT environment. For purposes of the present invention, each view will be referred to as an “application”. The multiple views may, for example, be generated by independently executable applications, or by a single executable application. In accordance with the present invention, a system is provided for designating the manner in which menu bars and tool bars are generated as a view is created (i.e. opened), loses focus, gains focus, or is destroyed (i.e. closed).

In the context of the present invention, a menu bar or tool bar refer to a set of persistent visual elements which appear on or about a parent pane of a window comprised of a parent frame and a plurality of child panes, and which set of elements can act on any one of the child panes when that child pane is in focus. In general, the term menu bar refers to a set of “pull-down” menus while the term tool bar refers to a set of “buttons”. Typical menu bar menus include “File”, “Edit”, “View”, “Insert”, “Format”, “Tools”, “Window”, and “Help”, each having a set of menu items. Typically, an MDI includes a single menu bar with a set of menus, which, in turn, include menu items. However, it is also possible to have multiple menu bars, each having their own respective sets of menus and menu items. Typical tool bar button items include create new file, open file, save file, cut, copy, paste, print, etc. In the context of the present invention, the term “menu” is used to refer to the individual menu bar menus, and the term “item” is used to collectively refer to menu bar items and tool bar button items. Finally, the term menu/tool bar entity is used to generically refer to menu bars, tool bars, menus, menu items, and tool bar items.

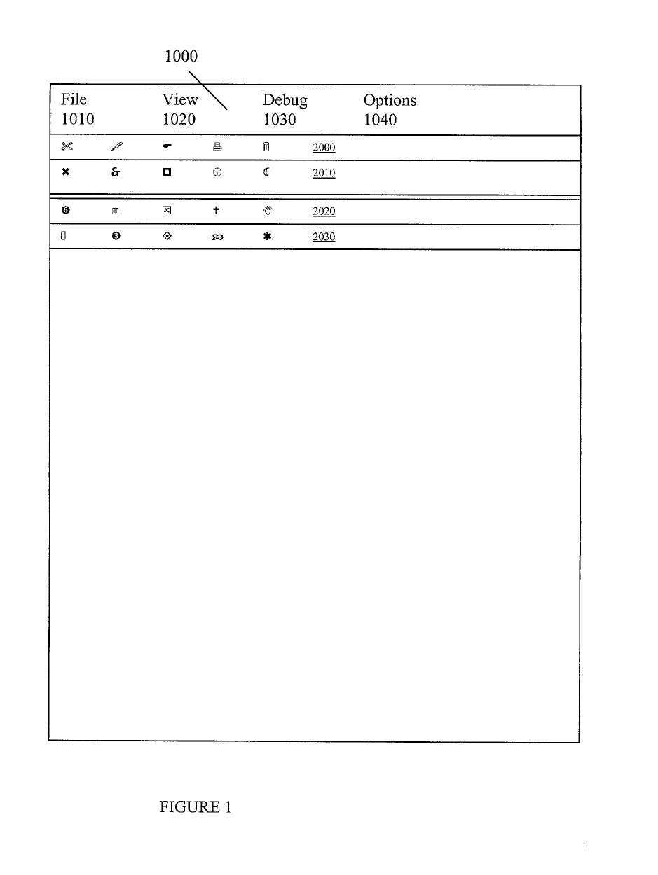

FIG. 1 shows an exemplary set of a menu bars and tool bars. In accordance with this embodiment, a system provides a MDI with a menu bar 1000 includes a File pull down menu 1010, a View pull down menu 1020, a Debug pull down menu 1030, and an Options pull down menu 1040. The MDI also includes a standard toolbar 2000, a task toolbar 2010, a domtoolbar 2020, and a view toolbar 2030. Preferably, at the user's option, one, some, all, or none of the menu bar 1000, and the toolbars 2000, 2010, 2020, and 2030 can be displayed at various locations on the parent frame of the MDI. It should be noted that the icons on the toolbars 2000-2030 are of an arbitrary nature, and are simply intended to show that the elements of a toolbar, as contrasted to a menu bar, are clickable buttons or some other form of user selectable item.

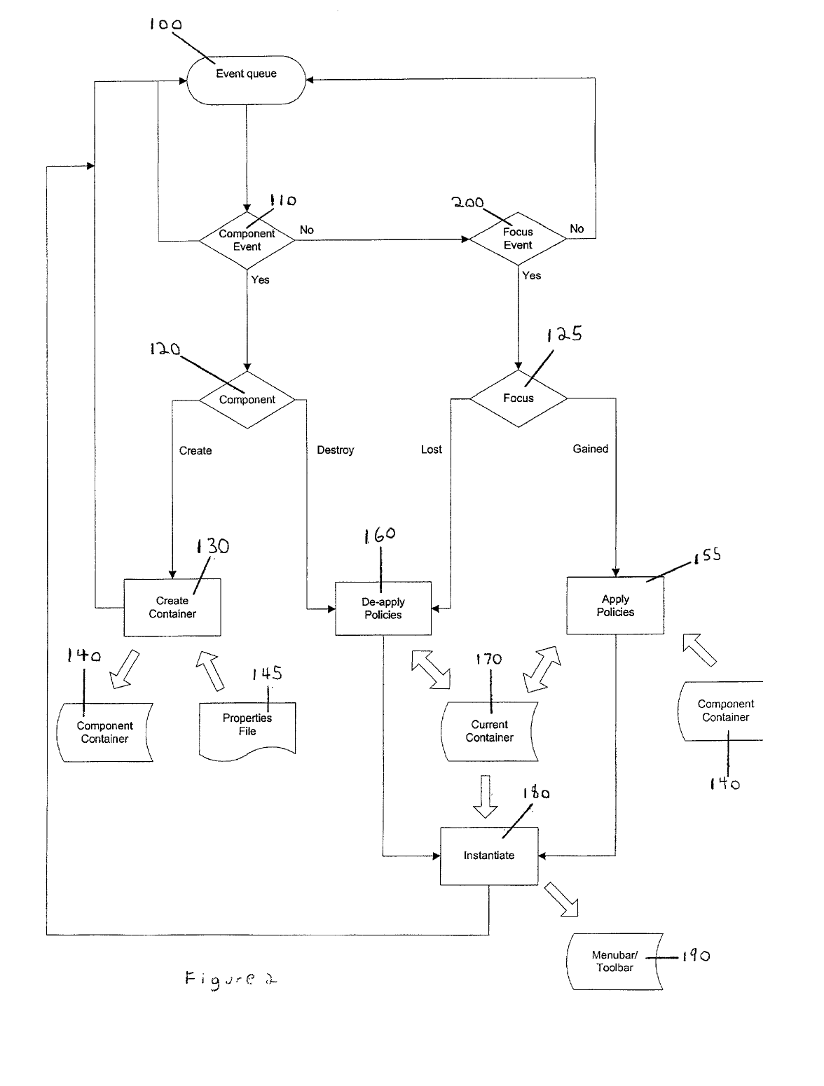

FIG. 2 shows a flow chart for a preferred system in accordance with the present invention. At step 100, the system monitors a current event on its event queue, and determines whether the current event, e.g., a user action or a message sent from another processing device is an application event (step 110 ). In this regard, an application event can be one of an application create event (i.e., the view is opened) or an application destroy event (i.e., the view is closed). If the event is not an application event, the system proceeds, at step 200, to determine whether or not the event is a focus event. A focus event can be one of a gain focus event (i.e., the view gains focus) or a lost focus event (i.e., the view loses focus). If the event is neither an application event or a focus event, control is returned to step 100. Preferably, the application that the event refers to is defined as a Java component.

If the event is an application event (step 110), the method determines if the application event is a create event or a destroy event (step 120). If it is create event (i.e. a previously closed application is invoked to create a view), a create container function is invoked (step 130 ). The create container function reads one or more policies from a properties file 145, and then integrates the policies into a container for the application (hereinafter an application container 140). Although a variety of programming techniques can be used to create the container, the container preferably conforms to the Java definition of a container. The method then returns to the event queue 100. If the application event is a destroy event, the application is destroyed (i.e. the view is closed), the policies for the application are de-applied (step 160), and a new menu/tool bar is created (or instantiated) based upon the policies of the active applications (i.e. those corresponding to the remaining open views, taking into account which view is in focus). After the instantiation, the method returns control to the event queue 100.

If the event is a focus event (step 200), the method proceeds to determine, in step 125 if the focus is lost or gained by the application. If the focus is lost, the method de-applies the policies for the application that lost the focus (step 160), and a new menu/tool bar is created in instantiation step 180, wherein a new menu/tool bar 190 is generated based upon the policies of the active applications, taking into account the change in focus. However, if focus is gained, the method applies the policies 155 of the container 140 of the application that gained focus, the container 140 of the application that gained focus is combined with the current container 170, and the method moves to the instantiation step 180, wherein a new menu/tool bar 190 is generated based upon the policies of the active applications, taking into account the change in focus.

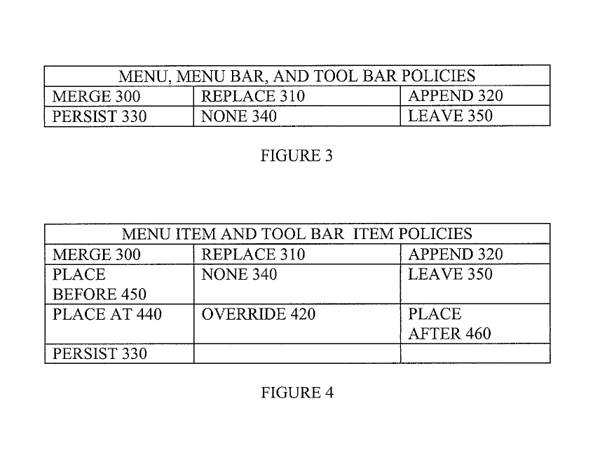

FIG. 3 is an illustrative representation of the policies that can be defined for the overall menu bar (in situations in which there is more than one), each menu in the menu bar, each item on a menu bar, the overall toolbar (in situations in which there is more than one), and for each item on a toolbar.

In this regard, each menu bar, menu, menu item, tool bar and toolbar item (collectively menu/tool bar entities”) includes an identifier which is used to associate similar menu/toolbar entities. Typically, the name of the menu, menu item, and toolbar item is simply the text name of the menu or item (e.g., File, paste, cut, etc.). As the displayed names of menu bars and toolbars tend to be more unique to the respective application view, the identifier of menu bars or toolbars are preferably selected so that similar menu bars or tool bars from various application views will have the same identifier. Using standard string matching techniques, similar identifiers could also be associated so that, for example, the identifier “undo” could be matched with the identifier “undo(last change).” In any event, the policies that can be defined are merge 300, replace 310, append 320, persist 330, none 340, and leave 350.

If the merge 300 policy defines a menu/toolbar entity in an application gaining focus, and a menu/toolbar entity with the same identifier (e.g., a menu name or icon) exists in the current menu bar or tool set, both menus or tool bars are merged together pursuant to the policies defined in the items of the respective menu or the respective toolbar (See Fig. 3). In this regard, if matching menu bars exist, a composite menu bar is generated which includes all of the underlying menus and menu items. If matching tool bars exist, a composite tool bar is generated which includes all of the underlying tool bar items. In both cases, the manner in which the underlying menus, menu items, and tool bar items are combined is governed by the policies listed for these respective menus, menu items, and tool bar items.

If the replace 310 policy is defined for a menu/toolbar entity of the menu bar or tool bar set, an application gaining focus, and the same identifier exists for a menu/toolbar entity in the current menu bar or toolbar set, the menu/toolbar entity having that identifier in the current menu bar or tool set is replaced with the menu/toolbar entity in the menu or toolbar set of the application gaining focus. If there is no menu/toolbar entity in the current menu or toolbar set with the same identifier, then the menu/toolbar entity from the menu bar or tool set of the application gaining focus is simply added to the current menu or toolbar set (i.e., the append 320 policy is applied). In any event, when the application loses focus, the menu/toolbar entity replaced will be reinstated. In accordance with this architecture, if a parent entity has a replace policy, there is no need to define policies for its child entities. For example, if the File menu of an application gaining focus has a Replace policy, then all of the menu items in the File menu of the current application will be replaced by the menu items in the File menu of the application gaining focus, regardless of any policies specified in the underlying menu items.

If the Append 320 policy is defined for a menu/toolbar entity, the menu/toolbar entity is added to the end of the menu bar or to the bottom of the tool set when the application gains focus. The appended menu or toolbar remains as long as the application stays in focus, and is de-applied once the application loses focus. In accordance with this architecture, if a parent entity has an append policy, there is no need to define policies for the child entities. For example, if the file menu of an application gaining focus has an append policy, then all of the menu items in the file menu gaining focus will be added to the file menu of the current application, regardless of any policies specified in the underlying menu items.

If the Persist 330 policy is defined for a menu/toolbar entity, the menu/toolbar entity is added to the end of the menu bar or to the bottom of the tool set as with the append 320 policy. However, the menu/toolbar entity remains in the menu or toolbar when the application loses focus, and is not removed until the application is destroyed. In all other respects, the Persist 330 policy is implemented in the same manner as the Append 320 policy.

None 340 policy is the default policy if no policy is defined. None 340 implements a replace 310 policy if possible. If the replace 310 policy can not be applied, e.g., there is no menu or toolbar with the same identifier in the menu bar or tool set, the append 320 policy is applied.

Finally, if the Leave 350 policy is defined for and menu/toolbar entity, no attempt is made to reconfigure the menu bar or tool set.

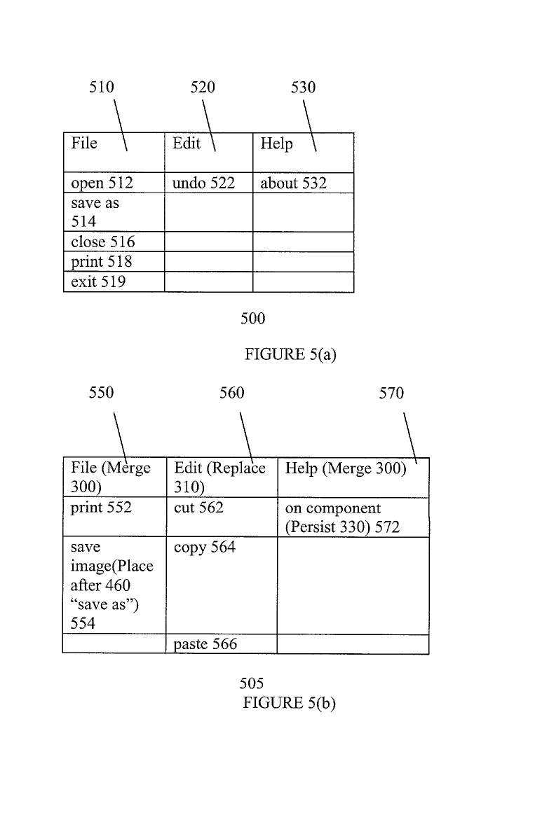

FIG. 4 shows the policies that can be defined for items, e.g., menu items or buttons, whose parent is defined by the “Merge” 300 policy. These policies include the merge policy 300, the replace policy 310, the append policy 320, the leave policy 350, the override policy 420, the persist 330 policy, the place at policy 440, the place before policy 450, the place after policy 460, and the none policy 340.

Merge policy 300 can be designated in the case of a menu item which includes cascading menu sub-items. In such a case, if the menu item of an application gaining focus has a merge policy, and a menu item exists in the current application with the same identifier, the underlying sub-items of the menu item in the application gaining focus are merged together with the corresponding menu item of the current application in accordance with the policies defined in the sub-items.

If an item replace 310 is defined for an item in an application gaining focus, and an item with the same identifier exists in the current application's menu or the toolbar, the item currently in the current menu bar or toolbar is replaced with the item in the application gaining focus. If there is no item in the menu or tool bar with the same identifier, then the item append 320 policy is applied. When the application loses the focus, the prior item is reinstated.

If an item in an application gaining focus has an Override 420 policy, and an item with the same identifier exists in the menu or toolbar of the current application, the item currently in the menu or toolbar is replaced with the item having the override policy.

However, unlike the replace 310 policy, the override 420 policy does not de-apply the policy when the application loses focus. Rather, the item remains until the application is destroyed. If there is no item in the menu or tool bar with the same identifier, then the item append 320 policy is applied. However, the item remains until the application is destroyed.

If an item in an application gaining focus has an Append 320 policy, the item is added at the end of the current menu or to the last button on the corresponding current toolbar. The item is retained as long as the application stays in focus, and is de-applied once the application loses focus.

If an item in an application gaining focus has a Persist 330 policy, the item is added as with the append 320 policy. However, the item remains when the application loses focus and is not removed until the application is destroyed.

An item Place At 440 policy in an item in an application gaining focus causes the item to be placed in the menu or toolbar at a designated position. An alphanumeric string may be used to indicate the position of the item and this string is associated to a same (or similar) string that may be attached to menu items in the current set of menu/toolbar entities. The item remains as long as the application stays in focus, and is de-applied once the application loses focus.

If an item in an application gaining focus has a Place Before 450 policy, that item is placed before a current item that is specified by its identifying name. For example, if the identifying name is “list” (e.g. Place Before List), the item will be placed before the current “list” item. If there is no item with the specified name, the system could, for example, apply the append policy as a default. The item remains as long as the application stays in focus, and is de-applied once the application loses focus.

Pursuant to an item Place After 460 policy, the item in an application gaining focus is placed after an item in the current application that is specified by an identifying name. For example, if the identifying name is “list” the item will be placed after the current “list” item. If there is no item with the specified name, the system could, for example, apply the append policy as a default. The item is retained as long as the application stays in focus, and is de-applied once the application loses focus.

If an item None 340 policy is selected, which is the default policy, the replace policy is applied, but if it is not possible to apply the replace policy, then the append policy is applied. For example, if there is no item with the same identifier in the current application, then the append policy is applied, since there are no items to replace.

Leave 350 policy, if designated, makes no changes to the menu bar or tool set, i.e., the leave policy 480 leaves the item off of the menu bar or tool set.

In accordance with other embodiments of the present invention, the persist policy can be used in conjunction with the other policies as a modifier. For example, as an alternative to specifying the override 420 policy the equivalent statement “replace+persist” in the properties file could apply the replace 310 policy and the persist 330 policy to the menu and toolbar. Thus, instead of de-applying the replace 310 policy when the application loses focus, the replace 310 policy would not be de-applied until the application is destroyed. Likewise, the persist policy 330 can, for example, be used as a modifier for the other policies such as append 320, merge 300 and others, by using the statements append+persist, merge+persist and the like. It should be noted that in the embodiment of FIG. 4, the persist 330 policy is equivalent to append+persist and the override 420 policy is equivalent to replace+persist.

In addition, although MDI applications do not generally change the menus on the menu bar or the order of the menus on the menu bar as the focus changes, the place at 440, place before 450, and place after 460 policies could be applied to the menu/toolbar entity, if desired.

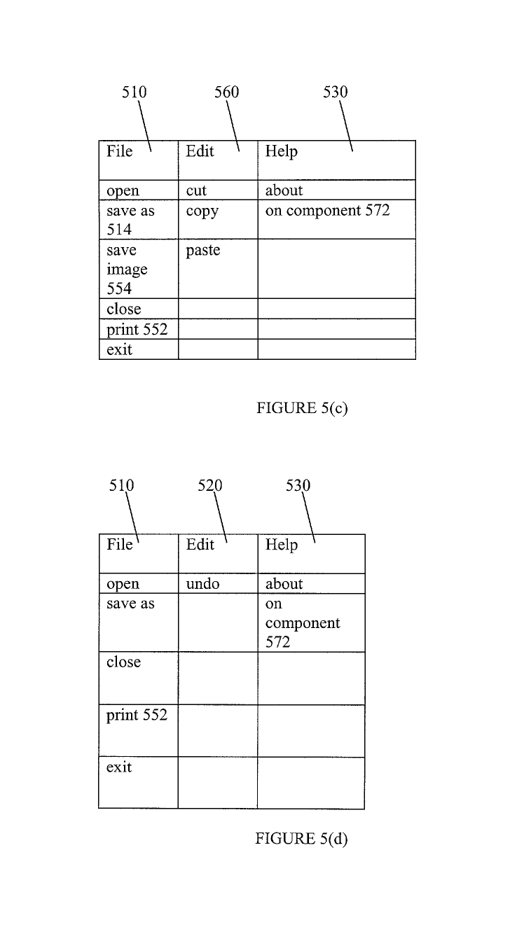

FIG. 5(a ) is an illustrative representation of a current menu 500 configuration for a current MDI view (i.e., the menu currently displayed to a user.) The current menu 500 contains a file menu 510, an edit menu 520, and a help menu 530. The file menu 510 contains an open item 512, a save as 514 item, a close 516 item, a print 518 item and an exit 519 item. The edit 520 menu contains an undo 522 item, and the help menu 530 contains an about 532 item.

FIG. 5(b ) is an illustrative representation of a menu configuration for a component 505. The menu configuration for the component 505 contains three component menus, a component file 550 menu, a component edit 560 menu, and a component help 570 menu. The component application's file menu 550 is set to the merge 300 policy and contains a component print 552 item and a component save image 554 item. The component save image 554 item is further defined by a place after 460 policy containing the alphanumeric string “save as.” A component edit 560 menu is defined by the replace 310 policy and contains a component cut 562 item, a component copy 564 item, and a component paste 566 item. The merge 300 policy is also defined for the component help 570 menu, and an on component 572 item contained in the component help 570 menu is further defined by the persist 330 policy.

FIG. 5(c ) is an illustrative representation of the menu bar after the component gains focus. Since the component file 550 menu has a merge 300 policy, the polices for each item of the component file 550 menu are applied. Thus, component save image 554 is placed after the save as 514 menu item, and the component print 552 item replaces the print 518 item of the current menu 500. The component edit 560 menu has a replace policy, which causes the entire component edit 560 menu to replace the edit 520 menu and in so doing to hide the undo 522 item. The component help 570 menu has a merge 300 policy, so the policies for each item of the component help 570 menu are applied. Consequently, the on component 572 item is appended to the help menu 530.

FIG. 5(d ) is an illustrative representation of the menu bar after the component 505 loses focus. When the component 505 loses focus, the policies for the component 505, except for the persist 330 policy, are de-applied. Thus, the menus 510,520,530 revert back to their prior state except for the help menu 530, where the on component 572 remains, since persist 330 policy is defined by the on component 572.

The policies underlying the tool bar and menu bar elements are contained in a properties file, and are read by the system as data (step 130 of FIG. 2) when a container is created for an application or view. A key property menubar can be used to introduce the individual menu items in the menu bar (e.g. menubar file edit help). The key property toolbars can be used to introduce a set of toolbars (e.g., toolbars =standard), and then the name defined can be used to further define the toolbar items (e.g. standard= cut edit paste). Table 1 shows a portion of an exemplary properties file which implements the menu elements of FIGS. 5(b ) as well as some toolbar elements:

TABLE 1

menubar = file edit help
file = print saveimage
edit = cut copy paste
help = oncomponent
fileLabel = File
editLabel = Edit
helpLabel = Help
printLabel = print
printImage = print.gif
saveimageLabel = Save image
cutLabel = cut
cutImage = cut.gif
copyLabel = copy
copyImage = copy.gif
pasteLabel = paste
pasteImage = paste.gif
oncomponentLabel = on component
toolbars = standard
standard = cut copy paste print
standardMDIName = Standard
fileMDIPolicy = Merge
editMDIPolicy = Replace
helpMDIPolicy = Merge
saveimageMDIPolicy = PlaceAfter-save as
oncomponentMDIPolicy = Persist
standardMDIPolicy = Merge

The component application's file menu 550 is set to the merge 300 policy by the statement “fileMDIPolicy—Merge” and the statement “saveimageMDIPolicy—PlaceAfter—save as” further defines the component save image 554 item. An “editMDIPolicy=Replace” statement defines the component edit 560 menu. The declaration “helpMDIPolicy=Merge” defines the component help 570 menu, and an “oncomponentMDIPolicy=Persist” further defines the oncomponent 572 item contained in the component help 570 menu. When a view corresponding to the application having this properties file (hereinafter “AA” ) gains focus, the print item on the menu will be replaced by AA's print item. Similarly the cut, copy, paste and print buttons on the current standard toolbar will be replaced by AA's buttons, or AA's buttons will be appended if such items do not exist on the current standard toolbar. The file menu will also receive a new menu item for saving an image and this will appear after the save as menu item. The edit menu on the current menu bar will be completely replaced by AA's edit menu. The help menu will have an on component item appended. When the component loses the focus all items will revert back to the way they were before the component gained the focus except for the on component entity on the help menu which will remain.

The present invention is also directed to any computer readable media having stored thereon the computer executable processes described above, including, without limitation, floppy disks, CD ROMs, tapes, hard disks, and the like.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for generating menu/toolbar entities on a graphical user interface having a parent frame for displaying menu/toolbar items and a plurality of child frames, comprising the steps of:
providing a set of applications which can be displayed in the plurality of child frames, each application having a corresponding set of menu/toolbar entities, information indicative of a policy for each menu/toolbar entity of each application being contained in a data file; and
generating a displayed set of menu/toolbar entities on the graphical user interface based upon the policies of the menu/toolbar entities for a currently focused one of the applications.

2. The method of claim 1, wherein each application has a corresponding data file.

3. The method of claim 1, wherein the providing step further includes selecting the policy for each menu/tool bar entity from a set of policies and placing information indicative of the policy into the data file, the set of policies including a replace policy and an append policy, each menu/toolbar entity having an identifier, and wherein
the generating step includes, for each menu/toolbar entity in an application gaining focus, comparing the identifier of the menu/toolbar entity to the identifier of each menu/toolbar entity in a current set of menu/toolbar entities, and, upon finding a match:
replacing the matched menu/toolbar entity of the current set of menu/toolbar entities with the matched menu/toolbar entity of the application gaining focus in the displayed set of menu/toolbar entities when the policy of the matched menu/toolbar entity of the application gaining focus is the replace policy;
adding the matched menu/toolbar entity of the application gaining focus to the displayed set of menu/toolbar entities when the policy of the matched menu/toolbar entity of the application gaining focus is the append policy.

4. The method of claim l, wherein the set of menu/toolbar entities includes a toolbar having a set of toolbar items, and a menu bar having a set of menus, each menu having a corresponding set of menu items, and wherein the menu bar, the toolbar, each menu, each menu item, and each toolbar item each have a respective policy.

5. The method of claim 4, wherein the providing step further includes
selecting the respective policy for each menu from a set of policies and placing information indicative of the policy into the data file, the set of policies including a merge policy, a replace policy and an append policy, each menu having an identifier, and wherein
the generating step includes, for each menu in an application gaining focus, comparing the identifier of the menu to the identifier of each menu in a current set of menu/toolbar entities, and, upon finding a match:
replacing the matched menu of the current set of menu/toolbar entities with the matched menu of the application gaining focus in the displayed set of menu/toolbar entities when the policy of the matched menu of the application gaining focus is the replace policy;
adding the matched menu of the application gaining focus to the displayed set of menu/toolbar entities when the policy of the matched menu of the application gaining focus is the append policy; and
generating the displayed set of menu/toolbar entities on the graphical user interface based upon the policies of the menu items of the matched menu of the application gaining focus, when the policy of the matched menu of the application gaining focus is the merge policy.

6. The method of claim 5, wherein the providing step further includes
selecting the respective policy for each tool bar from a set of policies and placing information indicative of the policy into the data file, the set of policies including a merge policy, a replace policy and an append policy, each tool bar having an identifier, and wherein
the generating step includes, for each tool bar in an application gaining focus, comparing the identifier of the tool bar to the identifier of each tool bar in a current set of menu/toolbar entities, and, upon finding a match:
replacing the matched tool bar of the current set of menu/toolbar entities with the matched tool bar of the application gaining focus in the displayed set of menu/toolbar entities when the policy of the matched tool bar of the application gaining focus is the replace policy;
adding the matched tool bar of the application gaining focus to the displayed set of menu/toolbar entities when the policy of the matched tool bar of the application gaining focus is the append policy; and
generating the displayed set of menu/toolbar entities on the graphical user interface based upon the policies of the tool bar items of the matched tool bar of the application gaining focus, when the policy of the matched tool bar of the application gaining focus is the merge policy.

7. The method of claim 6, further comprising the steps of, when the matched
menu bar has the merge policy:
selecting the respective policy for each menu item from a set of policies and placing information indicative of the policy into the data file, the set of policies including a replace policy and an append policy, each menu item having an identifier, and wherein
the generating step includes, for each menu item in an application gaining focus, comparing the identifier of the menu item to the identifier of each menu bar in a current set of menu/toolbar entities, and, upon finding a match:
replacing the matched menu item of the current set of menu/toolbar entities with the matched menu item of the application gaining focus in the displayed set of menu/toolbar entities when the policy of the matched menu item of the application gaining focus is the replace policy;
adding the matched menu item of the application gaining focus to the displayed set of menu/toolbar entities when the policy of the matched menu item of the application gaining focus is the append policy.

8. The method of claim 7, further comprising the steps of, when the matched tool
bar has the merge policy:
selecting the respective policy for each tool bar item from a set of policies and placing information indicative of the policy into the data file, the set of policies including a replace policy and an append policy, each tool bar item having an identifier, and wherein
the generating step includes, for each tool bar item in an application gaining focus, comparing the identifier of the tool bar item to the identifier of each tool bar item in a current set of menu/toolbar entities, and, upon finding a match:
replacing the matched tool bar item of the current set of menu/toolbar entities with the matched tool bar item of the application gaining focus in the displayed set of menu/toolbar entities when the policy of the matched tool bar item of the application gaining focus is the replace policy;
adding the matched tool bar item of the application gaining focus to the displayed set of menu/toolbar entities when the policy of the matched tool bar item of the application gaining focus is the append policy.

9. The method of claim 1, wherein the generating step includes the steps of:
monitoring an event queue for one of a create event, a destroy event, and a focus event;
upon detecting a create event, creating a JAVA container corresponding to an application which caused the create event using the information indicative of the policies of the application from the data file corresponding to the application;
upon detecting a gain focus event, applying the policies of an application gaining focus based upon information contained in the JAVA container for the application gaining focus;
upon detecting a lose focus event, deapplying the policies of an application losing focus based upon information contained in the JAVA container for the application losing focus; and
upon detecting a destroy event, destroying the JAVA container corresponding to an application which caused the destroy event.

10. The method of claim 4, wherein the providing step further includes
selecting the respective policy for each menu bar from a set of policies and placing information indicative of the policy into the data file, the set of policies including a merge policy, a replace policy and an append policy, each menu bar having an identifier, and wherein
the generating step includes, for each menu bar in an application gaining focus, comparing the identifier of the menu bar to the identifier of each menu in a current set of menu/toolbar entities, and, upon finding a match:
replacing the matched menu bar of the current set of menu/toolbar entities with the matched menu bar of the application gaining focus in the displayed set of menu/toolbar entities when the policy of the matched menu bar of the application gaining focus is the replace policy;
adding the matched menu bar of the application gaining focus to the displayed set of menu/toolbar entities when the policy of the matched menu bar of the application gaining focus is the append policy; and
generating the displayed set of menu/toolbar entities on the graphical user interface based upon the policies of the menus of the matched menu bar of the application gaining focus, when the policy of the matched menu bar of the application gaining focus is the merge policy.

11. A computer-readable medium, having stored thereon, computer executable process steps operative to control a computer to generating menu/toolbar entities on a graphical user interface having a parent frame for displaying menu/toolbar items and a plurality of child frames, the steps comprising:
providing a set of applications which can be displayed in the plurality of child frames, each application having a corresponding set of menu/toolbar entities, information indicative of a policy for each menu/toolbar entity of each application being contained in a data file; and
generating a displayed set of menu/toolbar entities on the graphical user interface based upon the policies of the menu/toolbar entities for a currently focused one of the applications.

12. The computer readable medium of claim 11, wherein each application has a corresponding data file.

13. The computer readable medium of claim 11, wherein the providing step further includes selecting the policy for each menu/tool bar entity from a set of policies and placing information indicative of the policy into the data file, the set of policies including a replace policy and an append policy, each menu/toolbar entity having an identifier, and wherein
the generating step includes, for each menu/toolbar entity in an application gaining focus, comparing the identifier of the menu/toolbar entity to the identifier of each menu/toolbar entity a current set of menu/toolbar entities, and, upon finding a match:
replacing the matched menu/toolbar entity of the current set of menu/toolbar entities with the matched menu/toolbar entity of the application gaining focus in the displayed set of menu/toolbar entities when the policy of the matched menu/toolbar entity of the application gaining focus is the replace policy;
adding the matched menu/toolbar entity of the application gaining focus to the displayed set of menu/toolbar entities when the policy of the matched menu/toolbar entity of the application gaining focus is the append policy.

14. The computer readable medium of claim 11, wherein the set of menu/toolbar entities includes a toolbar having a set of toolbar items, and a menu bar having a set of menus, each menu having a corresponding set of menu items, and wherein the menu bar, the toolbar, each menu, each menu item, and each toolbar item each have a respective policy.

15. The computer readable medium of claim 14, wherein the providing step further includes
selecting the respective policy for each menu from a set of policies and placing information indicative of the policy into the data file, the set of policies including a merge policy, a replace policy and an append policy, each menu having an identifier, and wherein
the generating step includes, for each menu in an application gaining focus, comparing the identifier of the menu to the identifier of each menu in a current set of menu/toolbar entities, and, upon finding a match:
replacing the matched menu of the current set of menu/toolbar entities with the matched menu of the application gaining focus in the displayed set of menu/toolbar entities when the policy of the matched menu of the application gaining focus is the replace policy;
adding the matched menu of the application gaining focus to the displayed set of menu/toolbar entities when the policy of the matched menu of the application gaining focus is the append policy; and
generating the displayed set of menu/toolbar entities on the graphical user interface based upon the policies of the menu items of the matched menu of the application gaining focus, when the policy of the matched menu of the application gaining focus is the merge policy.

16. The computer readable medium of claim 15, wherein the providing step further includes
selecting the respective policy for each tool bar from a set of policies and placing information indicative of the policy into the data file, the set of policies including a merge policy, a replace policy and an append policy, each tool bar having an identifier, and wherein
the generating step includes, for each tool bar in an application gaining focus, comparing the identifier of the tool bar to the identifier of each tool bar in a current set of menu/toolbar entities, and, upon finding a match:
replacing the matched tool bar of the current set of menu/toolbar entities with the matched tool bar of the application gaining focus in the displayed set of menu/toolbar entities when the policy of the matched tool bar of the application gaining focus is the replace policy;
adding the matched tool bar of the application gaining focus to the displayed set of menu/toolbar entities when the policy of the matched tool bar of the application gaining focus is the append policy; and
generating the displayed set of menu/toolbar entities on the graphical user interface based upon the policies of the tool bar items of the matched tool bar of the application gaining focus, when the policy of the matched tool bar of the application gaining focus is the merge policy.

17. The computer readable medium of claim 16, further comprising the steps of,
when the matched menu bar has the merge policy:
selecting the respective policy for each menu item from a set of policies and placing information indicative of the policy into the data file, the set of policies including a replace policy and an append policy, each menu item having an identifier, and wherein
the generating step includes, for each menu item in an application gaining focus, comparing the identifier of the menu item to the identifier of each menu bar in a current set of menu/toolbar entities, and, upon finding a match:
replacing the matched menu item of the current set of menu/toolbar entities with the matched menu item of the application gaining focus in the displayed set of menu/toolbar entities when the policy of the matched menu item of the application gaining focus is the replace policy;
adding the matched menu item of the application gaining focus to the displayed set of menu/toolbar entities when the policy of the matched menu item of the application gaining focus is the append policy.

18. The computer readable medium of claim 17, further comprising the steps of,
when the matched tool bar has the merge policy:
selecting the respective policy for each tool bar item from a set of policies and placing information indicative of the policy into the data file, the set of policies including a replace policy and an append policy, each tool bar item having an identifier, and wherein
the generating step includes, for each tool bar item in an application gaining focus, comparing the identifier of the tool bar item to the identifier of each tool bar item in a current set of menu/toolbar entities, and, upon finding a match:
replacing the matched tool bar item of the current set of menu/toolbar entities with the matched tool bar item of the application gaining focus in the displayed set of menu/toolbar entities when the policy of the matched tool bar item of the application gaining focus is the replace policy;
adding the matched tool bar item of the application gaining focus to the displayed set of menu/toolbar entities when the policy of the matched tool bar item of the application gaining focus is the append policy.

19. The computer readable medium of claim 11, wherein the generating step includes the steps of:
monitoring an event queue for one of a create event, a destroy event, and a focus event;
upon detecting a create event, creating a JAVA container corresponding to an application which caused the create event using the information indicative of the policies of the application from the data file corresponding to the application;
upon detecting a gain focus event, applying the policies of an application gaming focus based upon information contained in the JAVA container for the application gaining focus;
upon detecting a lose focus event, deapplying the policies of an application losing focus based upon information contained in the JAVA container for the application losing focus; and
upon detecting a destroy event, destroying the JAVA container corresponding to an application which caused the destroy event.

20. The computer readable medium of claim 14, wherein the providing step further includes
selecting the respective policy for each menu bar from a set of policies and placing information indicative of the policy into the data file, the set of policies including a merge policy, a replace policy and an append policy, each menu bar having an identifier, and wherein
the generating step includes, for each menu bar in an application gaining focus, comparing the identifier of the menu bar to the identifier of each menu in a current set of menu/toolbar entities, and, upon finding a match:
replacing the matched menu bar of the current set of menu/toolbar entities with the matched menu bar of the application gaining focus in the displayed set of menu/toolbar entities when the policy of the matched menu bar of the application gaining focus is the replace policy;
adding the matched menu bar of the application gaining focus to the displayed set of menu/toolbar entities when the policy of the matched menu bar of the application gaining focus is the append policy; and
generating the displayed set of menu/toolbar entities on the graphical user interface based upon the policies of the menus of the matched menu bar of the application gaining focus, when the policy of the matched menu bar of the application gaining focus is the merge policy.

21. A system for generating menu/toolbar entities on a graphical user interface having a parent frame for displaying menu/toolbar items and a plurality of child frames, comprising:
a display device for displaying the graphical user interface;
a computer processor coupled to a memory;
a set of applications stored in the memory which can be displayed in the plurality of child frames on the display device, each application having a corresponding set of menu/toolbar entities, information indicative of a policy for each menu/toolbar entity of each application being contained in a data file,
the computer processor generating a displayed set of menu/toolbar entities on the graphical user interface on the display device based upon the policies of the menu/toolbar entities for a currently focused one of the applications.

22. The system of claim 21, wherein each application has a corresponding data file.

23. The system of claim 21, wherein the policy for each menu/tool bar entity is selected from a set of policies and placing information indicative of the policy into the data file, the set of policies including a replace policy and an append policy, each menu/toolbar entity having an identifier, and wherein
the computer processor, for each menu/toolbar entity in an application gaining focus, compares the identifier of the menu/toolbar entity to the identifier of each menu/toolbar entity in a current set of menu/toolbar entities, and, upon finding a match:
replaces the matched menu/toolbar entity of the current set of menu/toolbar entities with the matched menu/toolbar entity of the application gaining focus in the displayed set of menu/toolbar entities when the policy of the matched menu/toolbar entity of the application gaining focus is the replace policy; and
adds the matched menu/toolbar entity of the application gaining focus to the displayed set of menu/toolbar entities when the policy of the matched menu/toolbar entity of the application gaining focus is the append policy.

24. The system of claim 21, wherein the set of menu/toolbar entities includes a toolbar having a set of toolbar items, and a menu bar having a set of menus, each menu having a corresponding set of menu items, and wherein the menu bar, the toolbar, each menu, each menu item, and each toolbar item each have a respective policy.

25. The system of claim 24, wherein the respective policy for each menu is selected from a set of policies and placing information indicative of the policy into the data file, the set of policies including a merge policy, a replace policy and an append policy, each menu having an identifier, and wherein
the computer processor, for each menu in an application gaining focus, compares the identifier of the menu to the identifier of each menu in a current set of menu/toolbar entities, and upon finding a match:
replaces the matched menu of the current set of menu/toolbar entities with the matched menu of the application gaining focus in the displayed set of menu/toolbar entities when the policy of the matched menu of the application gaining focus is the replace policy;
adds the matched menu of the application gaining focus to the displayed set of menu/toolbar entities when the policy of the matched menu of the application gaining focus is the append policy; and
generates the displayed set of menu/toolbar entities on the graphical user interface on the display device based upon the policies of the menu items of the matched menu of the application gaining focus, when the policy of the matched menu of the application gaining focus is the merge policy.

26. The system of claim 25, wherein the respective policy for each tool bar is selected from a set of policies and placing information indicative of the policy into the data file, the set of policies including a merge policy, a replace policy and an append policy, each tool bar having an identifier, and wherein
the computer processor, for each tool bar in an application gaining focus, compares the identifier of the tool bar to the identifier of each tool bar in a current set of menu/toolbar entities, and, upon finding a match:
replaces the matched tool bar of the current set of menu/toolbar entities with the matched tool bar of the application gaining focus in the displayed set of menu/toolbar entities when the policy of the matched tool bar of the application gaining focus is the replace policy;
adds the matched tool bar of the application gaining focus to the displayed set of menu/toolbar entities when the policy of the matched tool bar of the application gaining focus is the append policy; and
generates the displayed set of menu/toolbar entities on the graphical user interface on the display device based upon the policies of the tool bar items of the matched tool bar of the application gaining focus, when the policy of the matched tool bar of the application gaining focus is the merge policy.

27. The system of claim 26, wherein, when the matched menu bar has the merge policy, a respective policy for each menu item is selected from a set of policies and information indicative of the policy placed into the data file, the set of policies including a replace policy and an append policy, each menu item having an identifier, and wherein
the computer processor, for each menu item in an application gaining focus, compares the identifier of the menu item to the identifier of each menu item in a current set of menu/toolbar entities, and, upon finding a match:
replaces the matched menu item of the current set of menu/toolbar entities with the matched menu item of the application gaining focus in the displayed set of menu/toolbar entities when the policy of the matched menu item of the application gaining focus is the replace policy;
adds the matched menu item of the application gaining focus to the displayed set of menu/toolbar entities when the policy of the matched menu item of the application gaining focus is the append policy.

28. The system of claim 27, wherein, when the matched tool bar has the merge policy, a respective policy is selected for each tool bar item from a set of policies and information indicative of the policy is placed into the data file, the set of policies including a replace policy and an append policy, each tool bar item having an identifier, and wherein
the computer processor, for each tool bar item in an application gaining focus, compares the identifier of the tool bar item to the identifier of each tool bar item in a current set of menu/toolbar entities, and, upon finding a match:
replaces the matched tool bar item of the current set of menu/toolbar entities with the matched tool bar item of the application gaining focus in the displayed set of menu/toolbar entities when the policy of the matched tool bar item of the application gaining focus is the replace policy;
adds the matched tool bar item of the application gaining focus to the displayed set of menu/toolbar entities when the policy of the matched tool bar item of the application gaining focus is the append policy.

29. The system of claim 21, wherein the computer processor:
monitors an event queue for one of a create event, a destroy event, and a focus event;
upon detecting a create event, creates a JAVA container corresponding to an application which caused the create event using the information indicative of the policies of the application from the data file corresponding to the application;
upon detecting a gain focus event, applies the policies of an application gaining focus based upon information contained in the JAVA container for the application gaining focus;
upon detecting a lose focus event, deapplies the policies of an application losing focus based upon information contained in the JAVA container for the application losing focus; and
upon detecting a destroy event, destroys the JAVA container corresponding to an application which caused the destroy event.

30. The system of claim 24, wherein a respective policy is selected for each menu bar from a set of policies and information indicative of the policy is placed into the data file, the set of policies including a merge policy, a replace policy and an append policy, each menu bar having an identifier, and wherein
the computer processor, for each menu bar in an application gaining focus, compares the identifier of the menu bar to the identifier of each menu bar in a current set of menu/toolbar entities, and, upon finding a match:
replaces the matched menu bar of the current set of menu/toolbar entities with the matched menu bar of the application gaining focus in the displayed set of menu/toolbar entities when the policy of the matched menu bar of the application gaining focus is the replace policy;
adds the matched menu bar of the application gaining focus to the displayed set of menu/toolbar entities when the policy of the matched menu bar of the application gaining focus is the append policy; and
generates the displayed set of menu/toolbar entities on the graphical user interface based upon the policies of the menus of the matched menu bar of the application gaining focus, when the policy of the matched menu bar of the application gaining focus is the merge policy.

31. The method as recited in claim 9 wherein the step of upon detecting a destroy event further includes the step of deapplying the policies of an application being destroyed based upon information contained in the JAVA container for the application being destroyed.
